(19) United States
(12) Patent Application Publication
(10) Pub. No.: US 2006/0001711 A1
(43) Pub. Date: Jan. 5, 2006

(54) Inkjet printhead with multiple ink reservoirs

(75) Inventors: Jeffrey James Buchanan, Lexington, KY (US); Ganesh Vinayak Phatak, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/106,260

(22) Filed: Apr. 14, 2005

Related U.S. Application Data
(60) Provisional application No. 60/584,469, filed on Jul. 1, 2004.

(51) Int. Cl. B41J 2/175

(52) U.S. Cl. 347/86

(57) ABSTRACT

Some embodiments of the present invention provide an inkjet printhead comprising a housing and at least four ink reservoirs located in the housing. The housing can include an outer surface adapted to be covered by a chip in fluid communication with each of the at least four ink reservoirs. In some embodiments, the housing includes first and second ink vias positioned to fluidly couple first and second ink reservoirs to the outer surface. The first and second ink vias can each include a first end opening into the first and second ink reservoirs, respectively, and a second end opening to the outer surface. The inkjet printhead can have an orientation in which the outer surface lies in a substantially horizontal plane and in which the first ends of the first and second ink vias are positioned over the outer surface.

### CROSS-REFERENCE TO RELATED APPLICATIONS

This patent application claims the benefit of priority from U.S. provisional patent application No. 60/584,469 filed on Jun. 30, 2004 and entitled “Inkjet Printhead With Multiple Ink Reservoirs” the entire contents of which is hereby incorporated by reference.

### BACKGROUND OF THE INVENTION

Some inkjet printheads include a housing having one to three ink reservoirs which contain ink and supply ink to one or more chips. Inkjet printheads having one ink reservoir typically contain black or mono ink, whereas inkjet printheads having three ink reservoirs typically contain full or half-tone colors of magenta, cyan and yellow. Printers capable of printing in black-and-white and color are usually adapted to hold two printheads, one for black or mono ink, and one for color ink. Other printers are adapted to hold three printheads: one for black or mono ink, one for full-color ink, and one for half-tone color ink. In such printers, three printheads are normally required to obtain seven different ink colors or tones.

The greater the number of ink reservoirs in a printhead, the more difficult it becomes to plumb vias for the various inks to one chip. In some cases, inkjet printheads are provided with large and/or multiple chips in order to address this difficulty. However, this significantly increases the expense of the printhead.

### SUMMARY OF THE INVENTION

Some embodiments of the present invention provide an inkjet printhead comprising a housing; a first ink reservoir located in the housing; a second ink reservoir located in the housing, the second ink reservoir separated from the first ink reservoir by a first wall; a third ink reservoir located in the housing and separated from both the first ink reservoir and the second ink reservoir by a second wall, wherein the first wall lies in a plane intersecting the second wall; and a fourth ink reservoir located in the housing and positioned adjacent the third ink reservoir opposite the first ink reservoir and the second ink reservoir.

In some embodiments of the present invention, an inkjet printhead is provided, and comprises a housing; an outer surface of the housing adapted to be covered by a chip; a first ink reservoir located in the housing; a second ink reservoir located in the housing and separated from the first ink reservoir by a first wall; a first ink via positioned to fluidly couple the first ink reservoir to the outer surface, the first ink via having a first end opening into the first ink reservoir and a second end opening to the outer surface; a second ink via positioned to fluidly couple the second ink reservoir to the outer surface, the second ink via having a first end opening into the second ink reservoir and a second end opening to the outer surface, the printhead having an orientation in which the outer surface lies in a substantially horizontal plane and in which the first end of the first ink via and the first end of the second ink via are positioned over the outer surface.

Some embodiments of the present invention provide an inkjet printhead comprising a housing; a first ink reservoir located in the housing; a second ink reservoir located in the housing, the first ink reservoir separated from the second ink reservoir by a first wall; a third ink reservoir located in the housing and separated from both the first ink reservoir and the second ink reservoir by a second wall, wherein the first wall lies in a plane intersecting the second wall; and a fourth ink reservoir located in the housing and separated from the first ink reservoir and the third ink reservoir by a third wall, wherein the second wall lies in a plane intersecting the third wall.

In some embodiments of the present invention, an inkjet printhead is provided, and comprises a housing; an outer surface of the housing adapted to be covered by a chip, the printhead having an orientation in which the outer surface lies in a substantially horizontal plane; at least four ink reservoirs defined in the housing, each of the at least four reservoirs at least partially defined by an inner wall; and an intersection of each of the inner walls, wherein the intersection is located over the outer surface in the orientation of the printhead.

Some embodiments of the present invention provide an inkjet printhead comprising: a housing; an outer surface of the housing adapted to be covered by one chip; and at least four ink reservoirs located in the housing, each of the at least four ink reservoirs in fluid communication with the chip for supply of ink from the at least four ink reservoirs to the chip.

Other features and advantages of the invention will become apparent to those skilled in the art upon review of the following detailed description, claims and drawings.

### BRIEF DESCRIPTION OF THE DRAWINGS

FIG. 1 illustrates an perspective view of an embodiment of an inkjet printhead of the present invention.

FIG. 2 illustrates a top view of the inkjet printhead of FIG. 1.

FIG. 3 illustrates a cross-sectional perspective view of the inkjet printhead of FIGS. 1-2, taken along line 3-3 of FIG. 2, with filters shown.

FIG. 4 illustrates a detail cross-sectional perspective view of the inkjet printhead shown in FIG. 3.

FIG. 5 illustrates a bottom view of the inkjet printhead of FIGS. 1-4.

FIG. 6 illustrates a top view of another embodiment of an inkjet printhead of the present invention.

FIG. 7 illustrates a top view of another embodiment of the inkjet printhead of the present invention.

FIG. 8 illustrates a cross-sectional perspective view of the inkjet printhead of FIG. 7, taken along line 8-8 of FIG. 7.

FIG. 9 illustrates a detail cross-sectional perspective view of the inkjet printhead shown in FIG. 8.

FIG. 10 illustrates a bottom view of the inkjet printhead of FIGS. 7-9.

FIG. 11 illustrates a top view of another embodiment of the inkjet printhead of the present invention.

FIG. 12 illustrates a cross-sectional perspective view of the inkjet printhead of FIG. 11, taken along line 12-12 of FIG. 11.

FIG. 13 illustrates a detail cross-sectional perspective view of the inkjet printhead shown in FIG. 12.

FIG. 14 illustrates a bottom view of the inkjet printhead of FIGS. 11-13.

FIG. 15 illustrates a top view of another embodiment of the inkjet printhead of the present invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings.

Further aspects of the present invention, together with the organization and manner of operation thereof, will become apparent from the following detailed description of the invention when taken in conjunction with the accompanying drawings, wherein like elements have like numerals throughout the drawings.

### DETAILED DESCRIPTION

The present invention generally relates to a printhead comprising a housing and four or more ink reservoirs located in the housing. Each of the ink reservoirs is in fluid communication with an outer surface of the printhead, such that ink can be directed from each ink reservoir to a printing medium.

As used herein and in the appended claims, the term “ink” can refer to at least one of inks, dyes, stains, pigments, colorants, tints, a combination thereof, and any other material that can be used by inkjet printers to print matter upon a printing medium.

As used herein and in the appended claims, the term “printing medium” can refer to at least one of paper (including without limitation stock paper, stationary, tissue paper, homemade paper, and the like), film, tape, photo paper, a combination thereof, and any other medium upon which material can be printed by an inkjet printer.

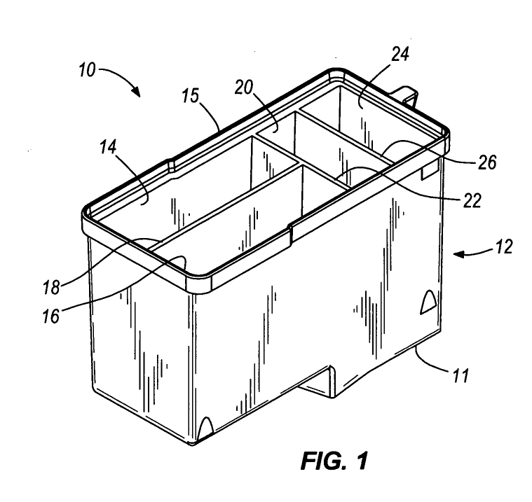

FIGS. 1-5 illustrate an inkjet printhead 10 according to an embodiment of the present invention. As shown in FIG. 1, the printhead 10 includes a housing 12 that defines a nosepiece 11 and four ink reservoirs 14, 16, 20, 24. In other embodiments, the housing 12 can have other shapes, some of which have no identifiable nosepiece. Each ink reservoir 14, 16, 20 and 24 contains ink, such as a quantity of ink filled within the reservoir 14, 16, 20, 24, and a foam insert saturated with ink. The housing 12 can be constructed of a variety of materials including, without limitation, at least one of polymers, metals, ceramics, composites, and the like.

As shown in FIG. 4, in some embodiments a chip 13 is coupled to the nosepiece 11 such that it covers an outer surface 17 (see FIGS. 3-5) of the nosepiece 11 and is in fluid communication with one or more of the four ink reservoirs 14, 16, 20, 24. As used herein and in the appended claims, the term “chip” can refer to one or more layers of material having one or more arrays of heat transducers, firing chambers and/or nozzles (not shown), at least one of the one or more layers being in fluid communication with one or more of the four ink reservoirs 14, 16, 20, 24. In some embodiments, such as that shown in FIGS. 1-5, the chip 13 can be coupled to the printhead 10 such that each of the ink reservoirs 14, 16, 20, 24 is in fluid communication with a respective set of heat transducers, firing chambers, and/or nozzle arrays 33 (see FIG. 4) in the chip 13. Due to the small size of the individual nozzles in the illustrated embodiment of FIGS. 1-5, the nozzle arrays 33 are represented by dashed lines in FIG. 4.

In some embodiments, ink is directed along a path from an ink reservoir 14, 16, 20 or 24 toward the outer surface 17 (and the chip 13, when the chip 13 is coupled to the outer surface 17), such that the ink enters one or more firing chambers, and is eventually fired from corresponding nozzles. Ink located in a firing chamber can be heated and vaporized by signaling a corresponding heat transducer to heat up the ink in the firing chamber. The ink can then be expelled outwardly from the printhead 10 through a corresponding nozzle toward a printing medium. In some embodiments, the chip 13 is in electrical communication with a printer controller that controls when various nozzles of the chip 13 fire ink toward a printing medium.

The inkjet printhead 10 in the illustrated embodiment of FIGS. 1-5 comprises four ink reservoirs 14, 16, 20, 24 located in the housing 12: a first ink reservoir 14, a second ink reservoir 16 separated from the first ink reservoir 14 by a first wall 18, a third ink reservoir 20 separated from both the first ink reservoir 14 and the second ink reservoir 16 by a second wall 22 that intersects the first wall 18, and a fourth ink reservoir 24 separated from the third ink reservoir 20 by a third wall 26. In this embodiment, the fourth ink reservoir 24 is positioned adjacent the third ink reservoir 20 opposite the first and second ink reservoirs 14, 16. Also in this embodiment, the third and fourth ink reservoirs 20, 24 are positioned generally above the nosepiece 11 of the housing 12, and specifically, over the outer surface 17 of the nosepiece 11 (and the chip 13, when the chip 13 is coupled to the printhead 10).

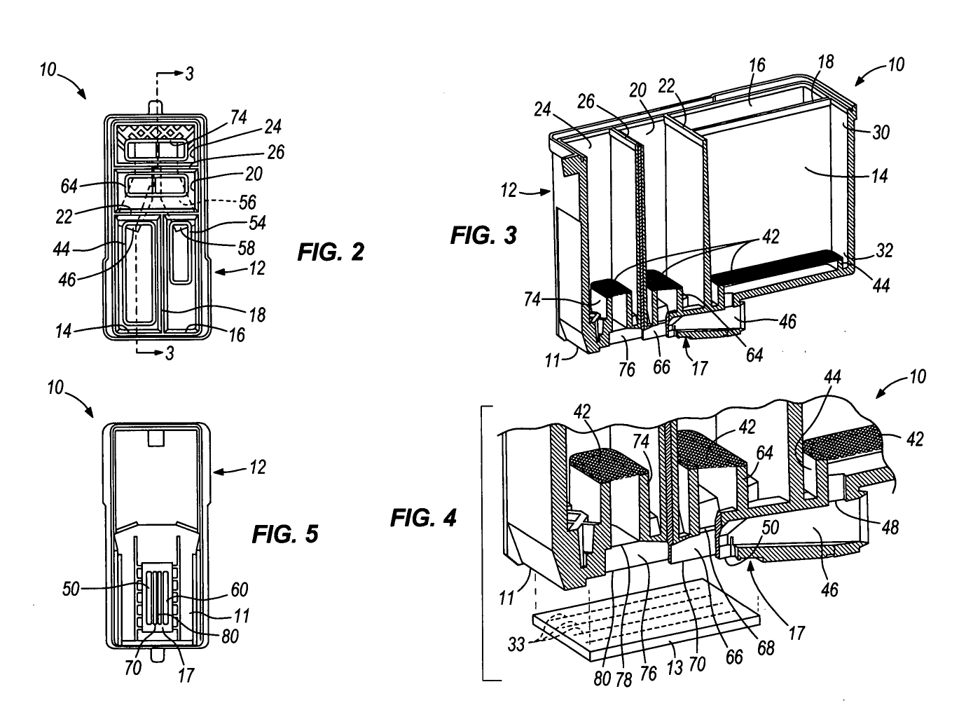

Each of the four ink reservoirs 14, 16, 20, 24 shown in FIG. 1 has a generally rectangular shape, with a length and a width smaller than the length (with reference to dimensions of the reservoirs 14, 16, 20, 24 viewed from above the housing 12 as shown in FIG. 2). The first and second ink reservoirs 14, 16 shown in FIG. 1 are oriented such that the length of the first ink reservoir 14 is substantially parallel with the length of the second ink reservoir 16. In addition, the third and fourth ink reservoirs 20, 24 shown in FIG. 1 are oriented such that the length of the third ink reservoir 20 is substantially parallel to the length of the fourth ink reservoir 24. Furthermore, the lengths of the first and second ink reservoirs 14, 16 in FIG. 1 are oriented substantially perpendicular to the lengths of the third and fourth ink reservoirs 20, 24. The third wall 26 separating the third ink reservoir 20 from the fourth ink reservoir 24 in the embodiment of FIGS. 1-5 is substantially parallel with the second wall 22. Accordingly, the first wall 18 that separates the first ink reservoir 14 from the second ink reservoir 16 is oriented substantially perpendicular to the second wall 22 and the third wall 26.

The housing 12 in the embodiment of FIGS. 1-5 is generally rectangular, and has a length and a width smaller than the length. In some embodiments, the lengths of the first and second ink reservoirs 14, 16 are substantially parallel with the length of the housing 12, and the lengths of the third and fourth ink reservoirs 20 and 24 are substantially parallel with the width of the housing 12. Other shapes of the housing 12 and ink reservoirs 14, 16, 20, 24 are possible, and fall within the spirit and scope of the present invention.

With continued reference to the embodiment of the inkjet printhead 10 illustrated in FIGS. 1-5, in some embodiments, the length of the first ink reservoir 14 is approximately equal to that of the second ink reservoir 16, and the length of the third ink reservoir 20 is approximately equal to that of the fourth ink reservoir 24. Also, in some embodiments, the length of the third ink reservoir 20 (or the length of the fourth ink reservoir 24) is approximately equal to the sum of the widths of the first and second ink reservoirs 14, 16. In such embodiments, if the widths of the first and second ink reservoirs 14, 16 are the same, the length of the third ink reservoir 20 (or the fourth ink reservoir 24) can be approximately equal to twice the width of the first ink reservoir 14 (or the second ink reservoir 16).

In some embodiments, the sum of the width of the third ink reservoir 20, the width of the fourth ink reservoir 24, and the length of the second ink reservoir 16 (or the first ink reservoir 14) is approximately equal to the length of the housing 12. In addition, in some embodiments the sum of the widths of the first and second ink reservoirs 14, 16 is approximately equal to the width of the housing 12, and the length of the third ink reservoir 20 (or the fourth ink reservoir 24) is approximately equal to the width of the housing 12. It should be noted, however, that the housing 12 has an outer wall 15 that has a thickness, thereby creating an inner and outer length and an inner and outer width of the housing 12. Therefore, as used herein and in the appended claims, the “length” of the housing 12 and the “width” of the housing 12 generally refers to the inner length and the inner width of the housing 12.

Each of the four ink reservoirs 14, 16, 20, 24 in the illustrated embodiment has an upper portion 30 and a lower portion 32, as shown in FIG. 3. As shown in FIGS. 2-4, each of the four ink reservoirs 14, 16, 20, 24 also includes a filter tower 44, 54, 64, 74 positioned adjacent the lower portion 32 to which a filter 42 can be coupled (see, for example, see FIGS. 3 and 4). It should be noted that a variety of types of filters 42 can be used in conjunction with the present invention. For example, the filters 42 illustrated in FIGS. 3 and 4 are woven filters with a relatively fine mesh size. In other embodiments, no filters 42 are used.

A filter 42 can be coupled to each filter tower 44, 54, 64, 74 in any of a variety of manners known in the art (e.g., laser welding, heat staking, etc.). Each filter tower 44, 54, 64, 74 is positioned such that the filter 42 contacts the ink, foam insert, or other ink-carrying element located within the respective ink reservoir 14, 16, 20 or 24. In some embodiments, the dimensions of each of the four ink reservoirs 14, 16, 20, 24 is at least partially determined by the accessibility needed to couple each filter 42 to its respective filter tower 44, 54, 64, 74. For example, the width of each of the four ink reservoirs 14, 16, 20, 24 can be at least partially determined by the size of a heat staking tool used to heat stake a filter 42 to an upper portion of each of the filter towers 44, 54, 64, 74. The filter towers 44, 54, 64, 74 shown in FIGS. 2-4 have a generally rectangular shape with rounded corners, although filter towers 4, 54, 64, 74 having any other shape can be used as desired.

The ink reservoirs 14, 16, 20, 24 and the filter towers 44, 54, 64, 74 (if used) are sized and shaped to control the rate of ink flow from the ink reservoirs 14, 16, 20, 24 toward the outer surface 17 (and the chip 13, when the chip 13 is coupled to the printhead 10). As shown in FIG. 2, the first ink reservoir 14 is the largest reservoir (having a width greater than that of the second ink reservoir 16). Also, the filter tower 44 of the first ink reservoir 14 is the largest. Accordingly, the first ink reservoir 14 can be used to contain black or mono ink, and the second ink reservoir 16, third ink reservoir 20 and fourth ink reservoir 24 can be used to hold a different color of ink (e.g., full-tone or half-tone magenta, full-tone or half-tone cyan, full-tone or half-tone yellow, black, white or gray, and the like). In some embodiments, all four ink reservoirs 14, 16, 20, 24 can have the same volume and be adapted to contain the same volume of ink. Also, in some embodiments, all four ink reservoirs 14, 16, 20, 24 can have the same volume, and the filter towers 44, 54, 64, 74 can be of the same size, such that each of the four ink reservoirs 14, 16, 20, 24 contains the same volume of ink and has the same flow rate of ink toward the outer surface 17. In still other embodiments, the ink reservoirs 14, 16, 20, 24 can have any other combination of relative volumes and can have filter towers 44, 54, 64, 74 in any combination of relative sizes desired.

The ink can flow from each of the four ink reservoirs 14, 16, 20, 24 toward the outer surface 17 (and the chip 13, when the chip 13 is coupled to the printhead 10) along one or more ink vias 46, 56, 66, 76 associated with each reservoir 14, 16, 20 or 24. As shown in FIGS. 2-4, the first ink reservoir 14 is in fluid communication with a filter 42, a first filter tower 44 and a first ink via 46 (shown in FIG. 2 in dotted lines). The first ink via 46 has a first end 48 (see FIG. 4) that opens into a bottom portion of the first filter tower 44 and a second end 50 (see FIGS. 4-5) that opens to the outer surface 17 (and the chip 13, when the chip 13 is coupled to the outer surface 17). In some embodiments, the first end 48 of the first ink via 46 has a cross-sectional area smaller than that of the first filter tower 44, such that the first end 48 opens into a volume within the first ink reservoir 14 that is surrounded by the first filter tower 44. Also, in some embodiments, a portion of the first ink via 46 traverses the second wall 22 to reach the second end 50 that opens to the outer surface 17, and a portion of the first ink via 46 traverses the third wall 26 to reach the second end 50 (the first ink via 46 is truncated in FIG. 4 for purposes of showing other portions of the printhead 10, but continues to extend past the third wall 26 as best shown in FIG. 2).

As shown in FIG. 2, the second ink reservoir 16 is in fluid communication with a filter 42, a second filter tower 54 and a second ink via 56. The second ink via 56 has a first end 58 (see FIG. 2) that opens into a bottom portion of the second filter tower 54 and a second end 60 (see FIG. 5) that opens to the outer surface 17 (and the chip 13, when the chip 13 is coupled to the outer surface 17). In some embodiments, the first end 58 of the second ink via 56 has a cross-sectional area smaller than that of the second filter tower 54 such that the first end 58 opens into a volume within the second ink reservoir 16 that is surrounded by the second filter tower 44. Also, in some embodiments, a portion of the second ink via 56 traverses the second wall 22 to reach the second end 60 that opens to the outer surface 17, and a portion of the second ink via 56 traverses the third wall 26 to reach the second end 60.

As shown in FIGS. 2-4, the third and fourth ink reservoirs 20, 24 are in fluid communication with third and fourth filters 42, third and fourth filter towers 64, 74 and third and fourth ink vias 66, 76, respectively. The third and fourth ink vias 66, 76 each have a first end 68, 78 (see FIG. 4), respectively, that opens into a bottom portion of the third and fourth filter towers 64, 74, respectively, and a second end 70, 80 (see FIGS. 4-5) that opens to the outer surface 17 (see FIG. 4). In some embodiments, the first ends 68, 78 of the third and fourth ink vias 66, 76 have cross-sectional areas smaller than that of the third and fourth filter towers 64, 74, respectively, such that the first ends 68, 78 open into a volume within the third and fourth ink reservoirs 20, 24 that is surrounded by the third and fourth filter towers 64, 74, respectively.

When the printhead 10 illustrated in FIGS. 1-5 is oriented such that the outer surface 17 lies in a substantially horizontal plane and in which the nosepiece 11 is pointed in a downward direction as shown in FIG. 1, at least a portion of each of the first ends 68, 78 of the third and fourth ink vias 66, 76 is located over the outer surface 17, such that the third and fourth ink vias 66, 76 are substantially vertical. In other words, when the printhead 10 is oriented such that the outer surface 17 lies in a substantially horizontal plane and in which the nozzle 11 is pointed in a downward direction, at least a portion of each of the first ends 68, 78 of the third and fourth ink vias 66, 76 is positioned substantially directly over the second end 70, 80 of the third and fourth ink vias 66, 76, respectively. It should be noted that the third and fourth ink vias 66, 76 can have other portions (e.g., branches, extensions, and the like) extending in other directions. However, in some embodiments, at least a portion of these vias 66, 76 is substantially vertical and provides an unobstructed straight path from the first ends 68, 78 of the vias 66, 76 to the outer surface 17 (and the chip 13, when the chip 13 is coupled to the outer surface 17).

It should be noted that the printhead 10 (as well as the printheads 100, 200, 300, 400 described below) can have any orientation. Some orientations of the printhead 10 or components of the printhead 10 (e.g., the outer surface 17) are identified herein and in the appended claims by reference to a substantially horizontal plane in which an element or feature of the printhead 10 lies. Also, some orientations of the printhead 10 or components of the printhead 10 (e.g., the third and fourth ink vias 66, 76), are identified herein and in the appended claims as being substantially vertical. Such orientations are referenced only to describe relative positions and orientations of features and elements of the printhead 10 rather than to indicate or imply that the printhead 10 must have any particular orientation in use.

Each of the four ink reservoirs 14, 16, 20, 24 illustrated in FIGS. 1-5 is in fluid communication with the outer surface 17, and with the chip 13, when the chip 13 is coupled to the outer surface 17. As a result, when the chip 13 is coupled to the outer surface 17, each of the four ink reservoirs 14, 16, 20, 24 is in fluid communication with one of the four nozzle arrays 32.

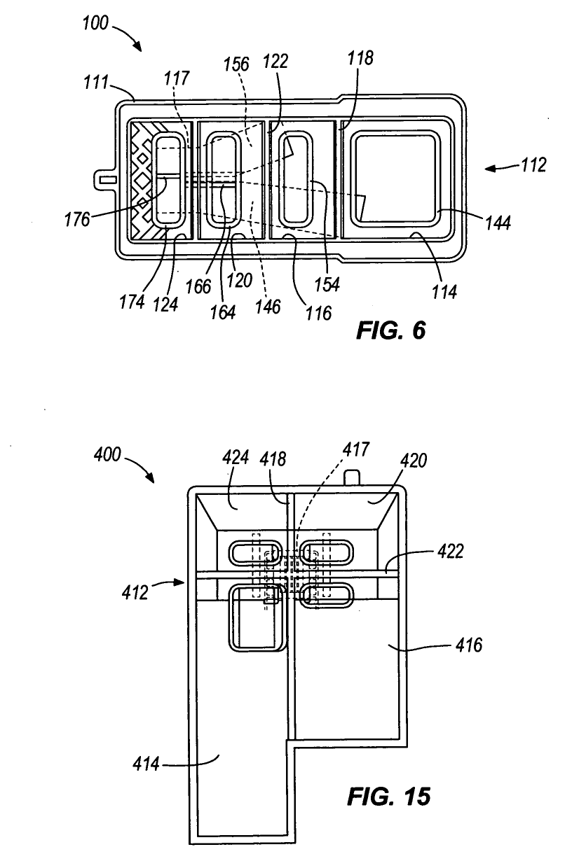

FIG. 6 illustrates a printhead 100 according to another embodiment of the present invention. The inkjet printhead 100 comprises four ink reservoirs 114, 116, 120, 124 located in a housing 112: a first ink reservoir 114, a second ink reservoir 116 separated from the first ink reservoir 114 by a first wall 118, a third ink reservoir 120 separated from the second ink reservoir 116 by a second wall 122 that is substantially parallel to the first wall 118, and a fourth ink reservoir 124 separated from the third ink reservoir 120 by a third wall 126 that is substantially parallel to the first and second walls 118, 122. The fourth ink reservoir 124 is positioned adjacent the third ink reservoir 120 opposite the second ink reservoir 116. The third and fourth ink reservoirs 120, 124 are positioned generally above a nosepiece 111 of the housing 112 (similar to the printhead 10 illustrated in FIGS. 1-5), and specifically, over the outer surface 117 adapted to be covered by a chip (and a chip, when a chip is coupled to the outer surface 117).

The printhead 100 illustrated in FIG. 6 includes many of the features of the printhead 10 illustrated in FIGS. 1-5. One difference between the printheads 10, 100 is that the third wall 126 of the housing 112 does not intersect the second wall 122. Also, the ink via 146 running from the first ink reservoir 114 toward the outer surface 117 runs beneath a portion of the second ink reservoir 116. Each of the four ink reservoirs 114, 116, 120, 124 is in fluid communication with the outer surface 117 of the housing 112 in a manner similar to that described above with respect to the printhead 10 illustrated in FIGS. 1-5. That is, for example, each of the ink reservoirs 114, 116, 120, 124 is in fluid communication with a respective filter tower 144, 154, 164, 174 and a respective ink via 146, 156, 166, 176 following a respective path toward the outer surface 117 of the printhead 110.

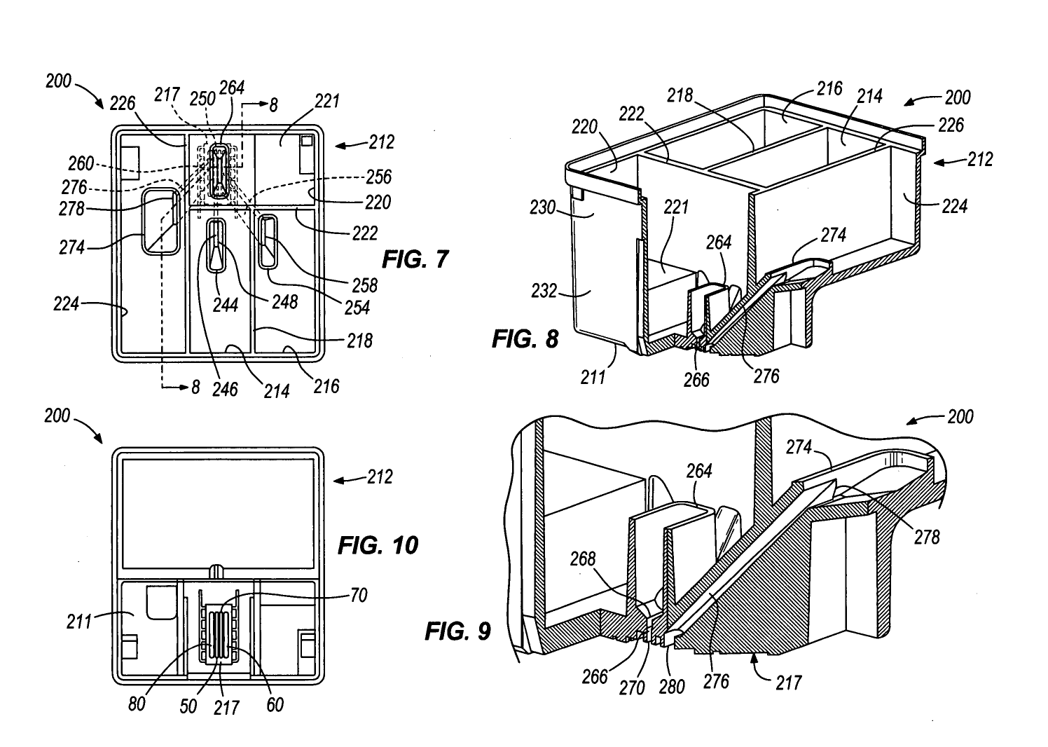

FIGS. 7-10 illustrate a printhead 200 according to another embodiment of the present invention. The printhead 200 comprises a housing 212 that defines a nosepiece 211 and four ink reservoirs 214, 216, 220, 224: a first ink reservoir 214, a second ink reservoir 216 separated from the first ink reservoir 214 by a first wall 218, a third ink reservoir 220 separated from both the first ink reservoir 214 and the second ink reservoir 216 by a second wall 222 that intersects the first wall 218, and a fourth ink reservoir 224 separated from the first ink reservoir 214 and the third ink reservoir 220 by a third wall 226 that intersects the second wall 222. In other embodiments, the housing 212 can have other shapes, some of which have no identifiable nosepiece. In the embodiment of the present invention shown in FIGS. 7 and 8, the first wall 218 is substantially parallel to the third wall 226, and the second wall 222 is substantially orthogonal to the first wall 218 and the third wall 226. It should be noted; however, that the first, second and third walls 218, 222 and 226 need not necessarily be oriented in this manner. For example, the walls 218, 222, and 226 can be configured in other manners in which the first wall 218 lies in a plane that intersects the second wall 222 and in which the second wall 222 lies in a plane that intersects the third wall 226.

Each of the four ink reservoirs 214, 216, 220, 224 illustrated in FIGS. 7-10 is generally rectangular. In some embodiments, the reservoirs 214, 216, 220, 224 each have a length and width shorter than the length. With reference to the embodiment illustrated in FIGS. 7-10, the lengths of the first, second and fourth ink reservoirs 214, 216 and 224 are all substantially parallel, and the length of the third ink reservoir 220 is oriented substantially orthogonally with respect to the first, second and fourth ink reservoirs 214, 216 and 224. In addition, the lengths of the first and second ink reservoirs 214, 216 in the embodiment of FIGS. 7-10 are substantially equal, whereas the length of the fourth ink reservoir 224 is greater than the lengths of the first and second ink reservoirs 214, 216. In some embodiments, the length of the fourth ink reservoir 224 is approximately equal to the sum of the length of the first ink reservoir 214 (or the second ink reservoir 216) and the width of the third ink reservoir 220 as best shown in FIG. 7.

In some embodiments, the length of the third ink reservoir 220 is less than the lengths of the first and second ink reservoirs 214, 216, and can be equal to the sum of the widths of the first and second ink reservoirs 214, 216. The first and second ink reservoirs 214, 216 can have approximately the same width. In such embodiments, the length of the third ink reservoir 220 can be equal to approximately twice the width of the first ink reservoir 214 (or the second ink reservoir 216).

The width of the third ink reservoir 220 can be greater than the width of the first ink reservoir 214 and/or the width of the second ink reservoir 216. Also, in some embodiments, the volume of the first ink reservoir 214 is equal to the volume of the second ink reservoir 216 and/or the volume of the third ink reservoir 220. Generally, the volume of the fourth ink reservoir 224 can be greater than that of any of the first, second and third ink reservoirs 214, 216 and 220, as shown in FIGS. 7-10. As a result, the fourth ink reservoir 224 can contain mono or black ink, and the first, second and third ink reservoirs 214, 216 and 220 can contain other colors of ink, as described above.

In addition, the housing 212 can be generally rectangular in shape, and can have a length and a width smaller than the length. In the illustrated embodiment of FIGS. 7-10, the length of the fourth ink reservoir 224 is approximately equal to the length of the housing 212. Also in this embodiment, the sum of the length of the third ink reservoir 220 and the width of the fourth ink reservoir 224 is approximately equal to the width of the housing 212. In other words, the sum of the widths of the first, second and fourth ink reservoirs 214, 216 and 224 is approximately equal to the width of the housing 212. In the embodiment illustrated in FIGS. 7-10, the width of the first ink reservoir 214 is approximately equal to the width of the second ink reservoir 216 and the width of the fourth ink reservoir 224. As a result, the width of the housing 212 is approximately equal to three times the width of the first ink reservoir 214 (or the width of the second ink reservoir 216, or the width of the fourth ink reservoir 224).

As with the other embodiments of the present invention, each ink reservoir 214, 216, 220, 224 in the embodiment of FIGS. 7-10 need not necessarily have a uniform height, length or width along the respective dimensions of the ink reservoir 214, 216, 220, 224. For example, the third ink reservoir 220 includes a step 221, such that the third ink reservoir 220 is shallower in depth (i.e., at the step 221) in one portion than the other. Specifically, the depth of the third ink reservoir 220 is greater adjacent a third filter tower 264 of the third ink reservoir 220.

As shown in hidden lines in FIG. 7 and in FIG. 10, the housing 212 has an outer surface 217 adapted to be covered by a chip (see, for example, the chip 13 illustrated in the embodiment of FIGS. 1-5). The third ink reservoir 220 in the embodiment of FIGS. 7-10 is positioned substantially over the outer surface 217 when the printhead 100 is in an orientation in which the outer surface 217 lies in a substantially horizontal plane and the nozzle 211 is pointed in a substantially downward direction. In other words, when the outer surface 217 is positioned substantially horizontally as just described, the outer surface 217 lies below the third ink reservoir 220.

Each of the four ink reservoirs 214, 216, 220, 224 has an upper portion 230 and a lower portion 232, as best shown in FIG. 8. As shown in FIGS. 7-9, each of the four ink reservoirs 214, 216, 220, 224 includes a filter tower 244, 254, 264, 274 positioned adjacent the lower portion 232 to which a filter (not shown) can be coupled. The filter can take any form and can be coupled in any manner as described above with reference to the embodiment of FIGS. 1-5.

As shown in FIG. 7, the first ink reservoir 214 is in fluid communication with a first filter tower 244 and a first ink via 246 (shown in dotted lines in FIG. 7). The first ink via 246 has a first end 248 that opens into a bottom portion of the first filter tower 244 and a second end 250 that opens to the outer surface 217 (and a chip, when a chip is coupled to the printhead 200). In some embodiments, the first end 248 of the first ink via 246 has a cross-sectional area smaller than that of the first filter tower 244 such that the first end 248 opens into a volume within the first ink reservoir 214 that is surrounded by the first filter tower 244. Also, in some embodiments, the first ink via 246 traverses the second wall 222 to reach the second end 250 that opens to the outer surface 217.

As further shown in FIG. 7, the second ink reservoir 216 is in fluid communication with a second filter tower 254 and a second ink via 256. The second ink via 256 (which can be similar to the first ink via 246) has a first end 258 that opens into a bottom portion of the second filter tower 254 and a second end 260 that opens to the outer surface 217. In some embodiments, the second ink via 256 traverses the first wall 218 and/or the second wall 222 to reach the second end 250 that opens to the outer surface 217.

As shown in FIGS. 7-9, the third ink reservoir 220 is in fluid communication with the third filter tower 264 and a third ink via 266. The third ink via 266 has a first end 268 that opens into a bottom portion of the third filter tower 264 and a second end 270 that opens to the outer surface 217. When the printhead 200 illustrated in FIGS. 7-10 is oriented such that the outer surface 217 lies in a substantially horizontal plane and the nozzle 211 is pointed in a substantially downward direction, the first end 268 of the third ink via 266 is located over the outer surface 217, such that the third ink via 266 is substantially vertical. In other words, when the printhead 200 is oriented such that the outer surface 217 lies in a substantially horizontal plane as just described, the first end 268 of the third ink via 266 is positioned substantially directly over the second end 270. It should be noted that the third ink via 266 can have other portions (e.g., branches, extensions, and the like) extending in other directions. However, in some embodiments, at least a portion of the third ink via 266 is substantially vertical and provides an unobstructed straight path from the first end 268 of the third ink via 266 to the outer surface 217 (and a chip, when the chip is coupled to the outer surface 217).

With continued reference to the embodiment of FIGS. 7-10, the fourth ink reservoir 224 is in fluid communication with a fourth filter tower 274 and a fourth ink via 276. The fourth ink via 276 has a first end 278 and second end 280 similar to those described above. In some embodiments, the fourth ink via 276 traverses the third wall 226 to reach the outer surface 217.

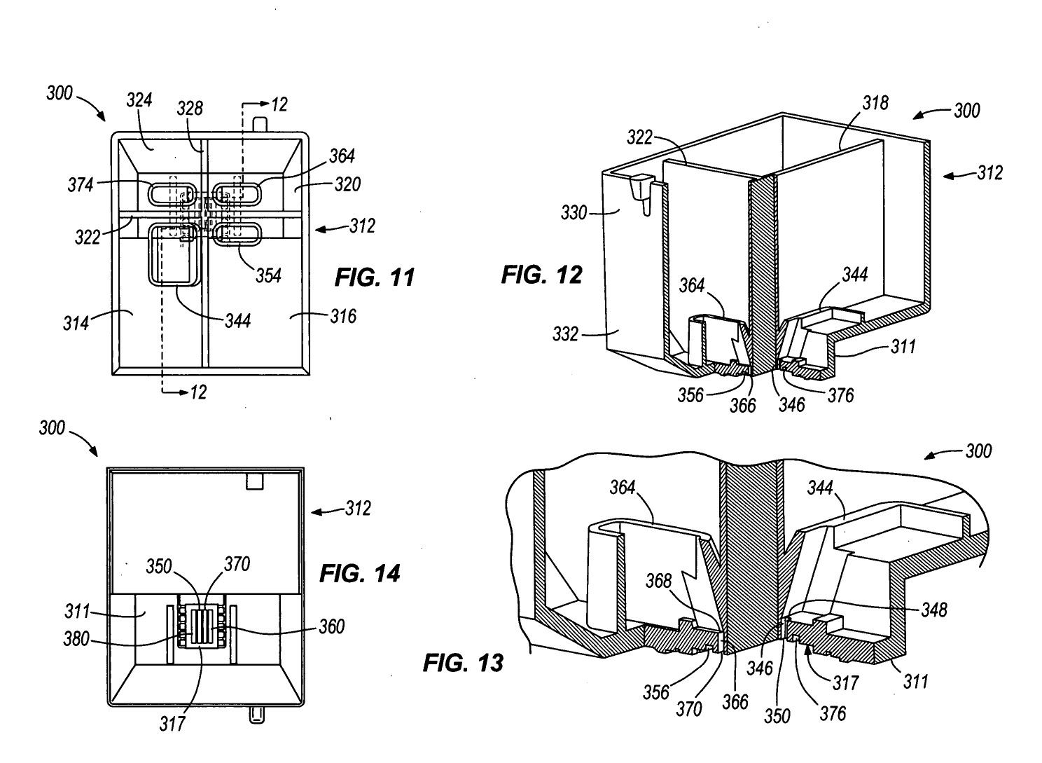

FIGS. 11-14 illustrate a printhead 300 according to another embodiment of the present invention. The printhead 300 comprises a housing 312 that defines a nosepiece 311. However, in other embodiments, the housing 212 can have other shapes, some of which have no identifiable nosepiece. The printhead 300 illustrated in FIGS. 11-14 has four ink reservoirs 314, 316, 320, 324: a first ink reservoir 314, a second ink reservoir 316 separated from the first ink reservoir 314 by a first wall 318, a third ink reservoir 320 separated from the second ink reservoir 316 by a second wall 322, and a fourth ink reservoir 324 separated from the first ink reservoir 314 by the second wall 322 and separated from the third ink reservoir 320 by the first wall 318. In some embodiments, the first wall 318 intersects the second wall 322 substantially at a right angle. However, it should be noted that the first wall 318 can intersect the second wall 322 at an angle other than a right angle.

Each of the four ink reservoirs 314, 316, 320, 324 can be generally rectangular, and can have a length and a width smaller than the length. In the illustrated embodiment of FIGS. 11-14, the length of the first ink reservoir 314 is substantially parallel with, and equal to, the length of the second ink reservoir 316. Also in this embodiment, the width of the first ink reservoir 314 is substantially parallel with, and equal to, the width of the second ink reservoir 316. Furthermore, the length of the third ink reservoir 320 can be substantially parallel with, and equal to, the length of the fourth ink reservoir 324, and the width of the third ink reservoir 320 can be substantially parallel with, and equal to, the width of the fourth ink reservoir 324. In some embodiments, the length of the third ink reservoir 320 and the length of the fourth ink reservoir 324 are oriented substantially orthogonally with respect to the length of the first ink reservoir 314 and the length of the second ink reservoir 316.

The housing 312 can be generally rectangular, and can have a length and width smaller than the length. In the embodiment of FIGS. 11-14, the sum of the length of the first ink reservoir 314 (or the second ink reservoir 316) and the width of the fourth ink reservoir 324 (or the third ink reservoir 320) is approximately equal to the length of the housing 312. Also in this embodiment, the sum of the lengths of the third and fourth ink reservoirs 320, 324 is approximately equal to the width of the housing 312, and the sum of the widths of the first and second ink reservoirs 314, 316 is approximately equal to the width of the housing 312.

Each of the four ink reservoirs 314, 316, 320, 324 has an upper portion 330 and a lower portion 332, as shown in FIG. 12. As shown in FIGS. 11-13, each of the four ink reservoirs 314, 316, 320, 324 includes a filter tower 344, 354, 364, 374 positioned adjacent the lower portion 332 to which a filter can be coupled. The filter can take any form and can be coupled in any manner as described above with reference to the embodiment of FIGS. 1-5. In some embodiments, each of the filter towers 344, 354, 364, 374 is positioned near the intersection of the first wall 318 and the second wall 322.

The housing 312 can have an outer surface 317 adapted to be covered by a chip (such as the chip 13 illustrated in the embodiment of FIGS. 1-5). In some embodiments, the intersection of the first wall 318 and the second wall 322 is positioned over the outer surface 317 when the printhead 300 is oriented such that the outer surface 317 lies in a substantially horizontal plane and the nozzle 311 is pointed in a substantially downward direction.

As best shown in FIGS. 11 and 13, the first ink reservoir 314 is in fluid communication with a first filter tower 344 and first ink via 346. The first ink via 346 has a first end 348 that opens into the first filter tower 344 and a second end 350 that opens to the outer surface 317.

The second ink reservoir 316 in the embodiment of FIGS. 11-14 is in fluid communication with a second filter tower 354 (see FIG. 11) and a second ink via 356 (see FIGS. 12 and 13). The second ink via 356 has a first end (not shown) that opens into the second filter tower 354 and a second end 360 that opens to the outer surface 317 (see FIG. 14).

The third ink reservoir 320 in the embodiment of FIGS. 11-14 is in fluid communication with a third filter tower 364 (see FIGS. 11-13) and a third ink via 366 (see FIGS. 12-13). The third ink via 366 has a first end 368 (see FIG. 13) that opens into the third filter tower 364 and a second end 370 that opens to the outer surface 317 (see FIGS. 13 and 14).

The fourth ink reservoir 324 in the embodiment of FIGS. 11-14 is in fluid communication with a fourth filter tower 374 (see FIG. 11) and a fourth ink via 376 (see FIGS. 12 and 13). The fourth ink via 376 has a first end (not shown) that opens into the fourth filter tower 374 and a second end 380 that opens to the outer surface 317 (see FIG. 14).

As shown in FIG. 12, the four ink vias 346, 356, 366, 376 can be positioned near the intersection of the first wall 318 and the second wall 322, which allows all of the four ink reservoirs 314, 316, 320, 324 to be in fluid communication with the same outer surface 317 (and same chip, when a chip is coupled to the printhead 300). Further, a chip having four nozzle arrays can be coupled to the outer surface 317 such that each of the four ink reservoirs 314, 316, 320, 324 is in fluid communication with one of the four nozzle arrays on the chip.

As shown in FIG. 14, in some embodiments, the second end 350 of the first ink via 346 opens to the outer surface 317 at a position such that the second end 350 is between openings corresponding to other ink vias 356, 366, 376 (e.g., openings 360, 370, 380 in the illustrated embodiment of FIGS. 11-14). However, it should be noted that the first ink reservoir 314 in the embodiment of FIGS. 11-14 has a larger filter tower 344 than the other filter towers 354, 364, 374, and can contain mono or black ink. Accordingly, in some embodiments, the second end 350 of the first ink via 346 opens to the outer surface 317 at a position that is not between openings corresponding to other ink vias, enabling the second end 350 and the first ink via 346 to be accessed more easily for service and maintenance. Such embodiments can be useful because mono or black ink is often the most frequently used ink.

FIG. 15 illustrates a printhead 400 according to another embodiment of the present invention, wherein like numerals represent like elements with respect to the printhead 300 illustrated in FIGS. 11-14. The printhead 400 shares many of the same elements and features described above with reference to printhead 300 of FIGS. 11-14. Accordingly, elements and features corresponding to elements and features in the printhead 300 of FIGS. 11-14 are provided with the same reference numerals in the 400 series. Reference is made to the description above accompanying FIGS. 11-14 for a more complete description of the features and elements (and alternatives to such features and elements) of the printhead 400 illustrated in FIG. 15.

The printhead 400 illustrated in FIG. 15 includes a first ink reservoir 414, a second ink reservoir 416, a third ink reservoir 420, and a fourth ink reservoir 424. The first ink reservoir 414 has a larger volume than that of the other ink reservoirs 416, 420, 424. In some embodiments, this larger volume is provided by a first ink reservoir 414 having a length greater than that of the second ink reservoir 416. In the illustrated embodiment of FIG. 15, the housing 412 has a first length and a second length. The sum of the length of the first ink reservoir 414 and the width of the fourth ink reservoir 424 in FIG. 15 is approximately equal to the first length of the housing 412. The sum of the length of the second ink reservoir 416 and the width of the third ink reservoir 420 is approximately equal to the second length of the housing 412.

The first ink reservoir 414 in the embodiment of FIG. 15 is larger than the other ink reservoirs 416, 420, 424 such that the first ink reservoir 414 can contain mono or black ink, while the other ink reservoirs 416, 420, 424 can contain other colors. The first ink reservoir 414 has been made larger than the other ink reservoirs 416, 420, 424 by extending the length of the first ink reservoir as mentioned above. Making the first ink reservoir 414 larger in this manner affords the printhead 400 many of the same relationships and features of the printhead 300 illustrated in FIGS. 11-14. For example, the intersection of the first wall 418 and the second wall 422 can be positioned over the outer surface 417 (and over a chip, when a chip is coupled to the outer surface 417), and the four ink reservoirs 414, 416, 420, 424 can all be in fluid communication with the same outer surface (and chip, when a chip is coupled to the outer surface 417).

It should be noted that the printheads 10, 100, 200, 300, 400 described above and illustrated in FIGS. 1-15 can include more than four ink reservoirs and maintain similar geometry and relationships without departing from the spirit and scope of the present invention.

In some embodiments described herein, the reservoirs are described as being separated by walls that are oriented substantially parallel with respect to one another or that intersect one another. In such cases, it should be noted that the walls can lie in planes oriented substantially parallel with respect to one another or that intersect one another.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. An inkjet printhead, comprising:
a housing;
an outer surface of the housing adapted to be covered by a chip;
a first ink reservoir located in the housing;
a second ink reservoir located in the housing and separated from the first ink reservoir by a first wall;
a first ink via positioned to fluidly couple the first ink reservoir to the outer surface, the first ink via having a first end opening into the first ink reservoir and a second end opening to the outer surface; and
a second ink via positioned to fluidly couple the second ink reservoir to the outer surface, the second ink via having a first end opening into the second ink reservoir and a second end opening to the outer surface, the printhead having an orientation in which the outer surface lies in a substantially horizontal plane and in which the first end of the first ink via and the first end of the second ink via are positioned over the outer surface.

2. The inkjet printhead of claim 1, wherein the first ink via and the second ink via are substantially vertical in the orientation of the printhead.

3. The inkjet printhead of claim 1, further comprising a third ink reservoir located in the housing and a fourth ink reservoir located in the housing, and wherein:
each of the first ink reservoir, the second ink reservoir, the third ink reservoir and the fourth ink reservoir have a length and a shorter width; and
the first ink reservoir and the second ink reservoir are positioned such that the lengths of the first ink reservoir and the second ink reservoir are substantially parallel.

4. The inkjet printhead of claim 3, wherein the third ink reservoir and the fourth ink reservoir are positioned such that the lengths of the third ink reservoir and the fourth ink reservoir are substantially parallel to one another and substantially perpendicular to the lengths of the first ink reservoir and the second ink reservoir.

5. The inkjet printhead of claim 1, further comprising:
a third ink reservoir located in the housing and separated from the second ink reservoir by a second wall; and
a fourth ink reservoir located in the housing and separated from the second ink reservoir by the second wall and the third ink reservoir by a third wall, wherein the third wall lies in a plane that intersects the second wall.

6. An inkjet printhead comprising:
a housing;
a first ink reservoir located in the housing;
a second ink reservoir located in the housing, the first ink reservoir separated from the second ink reservoir by a first wall;
a third ink reservoir located in the housing and separated from both the first ink reservoir and the second ink reservoir by a second wall, wherein the first wall lies in a plane intersecting the second wall; and
a fourth ink reservoir located in the housing and separated from the first ink reservoir and the third ink reservoir by a third wall, wherein the second wall lies in a plane intersecting the third wall.

7. The inkjet printhead of claim 6, wherein the first and second ink reservoirs each have a length and a shorter width, and wherein the first ink reservoir and the second ink reservoir are positioned such that the length of the first ink reservoir is substantially parallel with the length of the second ink reservoir.

8. The inkjet printhead of claim 7, wherein the third ink reservoir has a length and a shorter width, and wherein the length of the third ink reservoir is positioned substantially perpendicular with respect to the lengths of the first ink reservoir and the second ink reservoir.

9. The inkjet printhead of claim 6, wherein:
the first ink reservoir has a first dimension in a first direction;
the third ink reservoir has a second dimension in the first direction;
the fourth reservoir has a third dimension in the first direction; and
the third dimension is substantially equal to the sum of the first dimension and the second dimension.

10. The inkjet printhead of claim 6, further comprising:
an outer surface of the housing adapted to be covered by a chip, the printhead having an orientation in which the outer surface lies in a substantially horizontal plane and in which at least part of the outer surface is located below the third ink reservoir;
a first ink via through which fluid communication between the first ink reservoir and the outer surface is established, the first ink via passing through a first plane in which the second wall lies to reach the outer surface in the orientation of the printhead;
a second ink via through which fluid communication between the second ink reservoir and the outer surface is established, the second ink via passing through the first plane to reach the outer surface in the orientation of the printhead; and
a third ink through which fluid communication between the fourth ink reservoir and the outer surface is established, the third ink via passing through a second plane in which the third wall lies to reach the outer surface.

11. The inkjet printhead of claim 6, further comprising:
an outer surface of the housing adapted to be covered by a chip, the printhead having an orientation in which the outer surface lies in a substantially horizontal plane and in which at least part of the outer surface is located below the third ink reservoir;
an ink via through which fluid communication between the third ink reservoir and the outer surface is established, the ink via comprising a first end opening into the third ink reservoir and a second end opening to the outer surface, the first end being located above the outer surface in the orientation of the printhead.

12. An inkjet printhead comprising:
a housing;
an outer surface of the housing adapted to be covered by a chip, the printhead having an orientation in which the outer surface lies in a substantially horizontal plane;
at least four ink reservoirs defined in the housing, each of the at least four reservoirs at least partially defined by an inner wall; and
an intersection of each of the inner walls, wherein the intersection is located over the outer surface in the orientation of the printhead.

13. The inkjet printhead of claim 12, wherein the at least four ink reservoirs include:
a first ink reservoir;
a second ink reservoir separated from the first ink reservoir by a first wall;
a third ink reservoir separated from the second ink reservoir by a second wall; and
a fourth reservoir separated from the first ink reservoir by the second wall and separated from the third ink reservoir by the first wall.

14. The inkjet printhead of claim 13, wherein:
the housing has a length L;
the first ink reservoir has a length L₁ and a shorter width W₁;
the fourth ink reservoir has a width W₄ and a longer length; and
the sum of L₁ and W₄ is approximately equal to L.

15. The inkjet printhead of claim 13, wherein:
the housing has a length L;
the second ink reservoir has a length L₂;
the third ink reservoir has a width W₃; and
the sum of L₂ and W₃ is approximately equal to L.

16. The inkjet printhead of claim 13, wherein:
the housing has a width W;
the third ink reservoir has a length L₃;
the fourth ink reservoir has a length L₄; and
the sum of L₃ and L₄ is approximately equal to W.

17. The inkjet printhead of claim 13, wherein:
the housing has a first length Lₐ and a second length L_{b};
the first ink reservoir has a length L₁;
the second ink reservoir has a length L₂;
the third ink reservoir has a width W₃;
the fourth ink reservoir has a width W₄;
the sum of L₁ and W₄ is approximately equal to Lₐ; and
the sum L₂ and W₃ is approximately equal to L_{b}.

18. The inkjet printhead of claim 17, wherein Lₐ is greater than L_{b}.

19. The inkjet printhead of claim 12, further comprising:
a first inner wall positioned to separate a first ink reservoir from a second ink reservoir and to separate a third ink reservoir from a fourth ink reservoir;
a second inner wall positioned to separate the first ink reservoir from the fourth ink reservoir and to separate the second ink reservoir from the third ink reservoir, the first inner wall and the second inner wall at least partially defining the intersection.

20. The inkjet printhead of claim 12, further comprising:
at least four ink vias, each of the at least four ink vias positioned to fluidly couple each of the at least four ink reservoirs to the outer surface without passing through a plane in which any of the inner walls lie.

21. A disposable inkjet printhead, comprising:
a housing;
one chip disposed in a chip pocket of said housing;
at least four ink reservoirs disposed in said housing; and
an ink passage associated with each of said four or more ink reservoirs, said ink passages being integral to said housing;
wherein each of said ink passages converge to said one chip pocket.

22. The disposable inkjet printhead of claim 21, wherein each of said at least four ink reservoirs are substantially square or substantially rectangular in shape.

23. The disposable inkjet printhead of claim 21, wherein each of said at least four ink reservoirs share a common wall with at least one of said other at least four ink reservoirs.

24. The disposable inkjet printhead of claim 21, wherein at least one of said at least four ink reservoirs shares a first wall with a second of said at least four ink reservoirs and shares a second wall with a third of said at least four ink reservoirs.

25. The disposable inkjet printhead of claim 21, wherein said housing has an outer surface and at least one of said ink passages is bored into said housing such that an opening is created in said outer surface of said housing, said opening being sealed with a plug.

26. The disposable inkjet printhead of claim 21, wherein said housing has an outer surface and all of said ink passages are bored into said housing without creating an opening in said outer surface.
